(19) United States
(12) Patent Application Publication
(10) Pub. No.: US 2005/0066689 A1
(43) Pub. Date: Mar. 31, 2005

(54) Device and method for producing glass fibers

(76) Inventors: Wolfgang Eis, Niedernhausen (DE); Lothar Willmes, Hallgarten (DE)

Correspondence Address: LERNER AND GREENBERG, PA, P O BOX 2480, HOLLYWOOD, FL, 33022-2480, US

(21) Appl. No.: 10/770,617

(22) Filed: Feb. 2, 2004

Related U.S. Application Data
(60) Provisional application No. 60/506,082, filed on Sep. 25, 2003.

(51) Int. Cl. C03B 37/07

(52) U.S. Cl. 65/381; 65/495; 65/499; 65/488; 65/498; 65/384

(57) ABSTRACT

A device and a method for producing glass fibers from preforms use a fiber furnace having heating bushes and a follow-up device for holding and feeding the preforms. The glass fibers are passed on to a drawing and sizing installation and wound as fiber bundles on take-up spools. The heating bushes are disposed in a matrix-like configuration for receiving a number of preforms. The glass fibers are provided as a band such that the glass fibers are disposed next to one another when they are received by the drawing and sizing installation. The principal matrix axes have a given offset angle in relation to one another, such that the matrix-like configuration is preferably a rhomboid-shaped configuration. A flow device creates a predetermined air flow in the heating bushes. A temperature and cooling control creates predetermined temperature profiles in the heating bushes.

### CROSS-REFERENCE TO RELATED APPLICATION

This application claims the benefit under 35 U.S.C. § 119(e) of copending U.S. Provisional Application No. 60/506,082, filed Sep. 25, 2003.

### BACKGROUND OF THE INVENTION

Field of the Invention

The invention relates to a device for producing glass fibers from preforms, in particular multicomponent glass fibers, with a fiber furnace having heating bushes, with a follow-up device for holding and feeding the preforms in the heating bushes and a drawing and sizing installation for passing on the glass fibers to a making-up device. The invention further relates to a method for producing glass fibers from preforms, wherein preforms are introduced by a follow-up device into the heating bushes of the fiber furnace, and the glass fibers drawn from the heating bushes are cooled in a downstream cooling zone and are passed on via a drawing installation to a making-up device.

In conventional devices and methods for producing glass fibers, preforms are introduced into heating bushes and melted. The glass flows off continuously from the preforms and is drawn from the heating bushes underneath the fiber furnace.

Preforms include at least a rod of a specific glass material with a predetermined diameter. For the use of multicomponent glass fibers in glass fiber bundles, however, it is necessary that the glass fibers have a certain quality with regard to the diameter of each glass fiber or the diameter variance of a number of glass fibers produced simultaneously, an optimum reflectivity being necessary for the light conducted through the glass fiber. These properties are achieved in the case of multicomponent glass fibers by multi-layered preforms, which include a core rod and, for example, a cladding tube. The glass fibers drawn from this have a core and a cladding connected thereto. In this case, the high reflection properties are produced by the cladding, which has a specific refractive index. The core rod is formed of a material with a higher refractive index than the cladding material, in order to ensure the light-conducting and optical properties.

When melting the preform, the dripping of the first glass drop has the effect that the cladding material is drawn over the core material and the two materials unite.

To keep the material thicknesses constant and to create optimal optical properties of the different materials in the glass fibers, it is necessary that the diameters of the glass fibers are kept constant. In addition, the temperature profiles in the fiber furnace are of decisive importance for the optical and mechanical properties of the glass fibers produced from them.

Different methods of producing glass fibers are used depending mainly on the type and quality of the glass fibers to be produced, or the rate of fiber creation and the number of glass fibers to be produced simultaneously.

Published U.S. Patent Application No. 2003/0079501 A1 discloses a multiple drawing installation for glass fibers which are drawn from single-layer preforms. These preforms generally are formed of quartz glass, which is melted at 2000° C. in a draw furnace. From the draw furnace, a fiber is drawn off, its diameter is checked or measured with regard to accuracy by a corresponding device in a draw tower and it is subsequently coated with a polymer material. After that, the fiber is wound up on a take-up spool. The fibers produced in this way from quartz glass are used in telecommunications technology or for data transmission.

Because of the increased requirements on the accuracy of the diameter and because of the consequently necessitated testing measures, they are always drawn individually and also individually post-processed after the draw furnace. The improvements which were recognized by Published U.S. Patent Application No. 2003/0079501 A1 in comparison with a prior production method of individual fibers are that a number of autonomously operating devices for producing individual fibers can be connected in parallel, in order to allow a corresponding number of glass fibers to be produced simultaneously.

This type of production is unsuitable for the creation of multicomponent glass fibers, since a plurality of glass fibers in glass fiber bundles which have to satisfy different requirements with regard to the accuracy of the diameter and the coating are usually used. It has been found that cost-effective production of such glass fiber bundles with individual fiber drawing devices is not possible even if a number of them are connected in parallel.

In particular, it has been found as a disadvantage of such devices that, in spite of the parallel connection of a number of individual fiber drawing installations, the number of glass fibers is limited considerably below what is necessary. For the cost-effective production of glass fiber bundles, a plurality of individual fibers should be produced simultaneously. The post-processing relating to the individual fiber also entails considerable costs in the case of the device according to the prior art, so that the creation of fiber bundles for optical systems would consequently be uneconomical.

In comparison with the glass fibers used for data transmission, the concern in the case of multicomponent glass fibers is less for the quality of the individual fibers than for the quality of the complete fiber bundle. In addition, unlike in the case of data transmission fibers, considerations of cost-effectiveness play a significantly greater role for the use of glass fiber bundles including multicomponent glass fibers.

It has been found that, with individual guidance of the glass fibers, as represented in the aforementioned prior art, these requirements cannot be ensured.

### SUMMARY OF THE INVENTION

It is accordingly an object of the invention to provide a device and a method for producing optical glass fibers which overcome the above-mentioned disadvantages of the heretofore-known devices and methods of this general type and which satisfy the above-described quality requirements, and with which an adequate number of glass fibers can be produced simultaneously, preferably from multi-layered preforms.

With the foregoing and other objects in view there is provided, in accordance with the invention, a device for producing optical glass fibers, including:
a fiber furnace having heating bushes disposed as a matrix configuration for simultaneously receiving a number of preforms;
a follow-up device configured to hold and feed the preforms into the heating bushes;
a drawing and sizing installation configured to receive glass fibers drawn from the preforms in the heating bushes such that the glass fibers lie next to one another as a band when being received by the drawing and sizing installation; and
a making-up device configured to receive the glass fibers from the drawing and sizing installation.

In other words, according to the invention, there is provided, a device for producing optical glass fibers from preforms, in particular multicomponent glass fibers, with a fiber furnace having heating bushes, with a follow-up device for holding and following up the preforms in the heating bushes and a drawing and sizing installation for passing on the glass fibers to a making-up device, wherein the heating bushes in the fiber furnace have a matrix-like configuration for simultaneously receiving a number of preforms and wherein the glass fibers drawn from the heating bushes can be received lying in band form next to one another by the drawing and sizing installation.

The configuration of the heating bushes ensures in this case that the glass fibers can be drawn out of the fiber furnace with a small offset distance from one another. In this case it is possible to deflect the glass fibers accordingly on a downstream roller.

The offset of the glass fibers is achieved by the principal matrix axes being arranged with a predetermined offset angle in relation to one another. For this purpose, it is advantageously provided that the heating bushes are disposed in the fiber furnace in a rhomboid manner. In this case, it is further provided that the distance between the directly neighboring heating bushes on each matrix axis is the same. Furthermore, it is provided that the heating bushes are arranged in one plane.

With the device according to the invention, a plurality of preforms can be synchronously passed through the heating bushes and the glass fibers produced in the fiber furnace can be drawn with a predetermined drawing rate from the preforms located in the heating bushes. In this case, it is provided according to the invention that the glass fibers are deflected on at least one downstream deflection roller, without touching or crossing one another. Consequently, the glass fibers are drawn altogether with the same drawing rate from the heating bushes of the fiber furnace.

As a result of the fact that each preform guided by the follow-up device has an associated heating bush, simultaneous drawing of glass fibers from all the preforms is made possible.

An advantageous embodiment of the device is provided according to the invention by the fiber furnace having at least 110 heating bushes. In this case, a favorable configuration can be achieved by the matrix structure having 10 heating bushes in the direction of one principal matrix axis and 11 heating bushes in the direction of the other principal matrix axis. This is because it has been found that advantageous utilization of the heating output of all the heating bushes can be optimized better with a greater number of heating bushes. In this case, undesired temperature fluctuations are already kept small by an advantageous mechanical layout. In the case of this embodiment, the glass fibers from one half of the fiber furnace in each case are passed on to a respective deflection roller and in each case to a sizing installation.

In order to ensure the desired and required temperature profile, it is provided that the fiber furnace has a temperature controller and that the temperature controller includes individual controllers of the internal heating bush temperature. Consequently, both the overall temperature and the temperatures of the individual heating bushes can be monitored and controlled through the use of the temperature controller. This allows an individual adaptation of the temperature profile to external and internal influencing factors.

In order to respectively determine the temperatures and individually change the temperatures of the individual heating bushes, it is proposed according to the invention that the individual controllers have measuring and compensating devices for matching the temperatures of the heating bushes to the neighboring heating bushes. For this purpose, sensors which are connected to the temperature controller are provided inside the heating bushes. The temperatures of the individual heating bushes are controlled through the use of the sensor values. All the heating bushes are heated to a setpoint value, which lies in the range between approximately 800° C. and 1100° C. Consequently, the individual controller can advantageously achieve the effect that all the heating bushes are individually controlled to the setpoint value. Respective offset settings are used to compensate for disturbances which cause the heating bushes to have temperatures deviating from one another and altogether from the setpoint value. All the heating bushes are in this case controlled to the same setpoint value within a temperature band of approximately 1° C. In order to compensate for temperature differences between the heating bushes, the temperature difference is recorded at regular intervals for each heating bush and the value determined is subtracted from or added to the offset. Consequently, the offset setting can likewise be used to compensate for long-term effects, such as aging of the thermocouples and heating bushes or other disturbances from outside the heating bushes. The compensating devices include heating and cooling elements, for example electronic components, with which the temperatures in the heating bushes can be raised or lowered, according to requirements. It is consequently possible in an advantageous way to set defined states of the heating bushes and consequently of the overall system of the fiber furnace.

Furthermore, it is proposed according to the invention that each heating bush has at least one heating element, preferably a number of separately activatable heating coils, and that at least one diffuser is arranged between the heating element and the preform for diffusing the heating radiation. An advantage of this embodiment is that, with a number of heating coils, on the one hand an exactly calculated temperature profile can be set in the heating bush. On the other hand, steep temperature gradients are smoothed by the diffuser. In this case it is provided that the diffuser preferably includes a quartz tube and that the preform can be passed through the quartz glass by the follow-up device.

Inside the heating bush, but in particular inside the quartz tube, undesired flow conditions may arise, leading to the preform being exposed to cold air. In order to avoid this, it is proposed according to the invention that each heating bush has a flow device for creating a laminar air flow in the heating bush. This makes it possible to set precalculated flow conditions in an advantageous way. In this case it is provided that the flow device includes an extension which is preferably connected in one piece to the diffuser, is arranged in the lower part of the heating bush and is free from heating elements. This has the effect that an air cushion can form under the heating bush, wherein the air cushion is heated up by the heating radiation. The heated-up air is conducted into the heating bush. In order that the flow rate of the air introduced does not thereby increase undesirably, it is provided according to the invention that the flow device includes at the upper end of the heating bushes at least one flow baffle, which ensures an annular gap with a predetermined gap width around the performs for the venting of air. The flow baffle makes it possible to influence the rate of the laminar airflow by fixing the annular gap in the upper region of the heating bush. It is also possible to use a number of flow baffles with different outside diameters, made to match the annular gaps respectively to be covered. It is consequently possible in a simple way to adapt the annular gap to various diameters of preforms or to respond to changes of the flow conditions in a heating bush during the drawing process. In this case, it is provided in an advantageous embodiment that the heating bushes in the entire fiber furnace have the same annular gaps.

According to the invention, it is further proposed that the follow-up device has a supporting plate with individual suspensions for receiving the individual preforms. Consequently, each preform can be individually suspended. If there is a small number of glass fibers to be produced, some of the individual suspensions may also remain empty.

It is also advantageously provided that the individual suspensions on the supporting plate have a matrix-like configuration corresponding to the configuration of heating bushes. This makes it possible for the preforms to be introduced axially symmetrically in relation to the axes of the heating bushes and to avoid deviations of the distance of the edge of the preforms from their respective heating bush.

In an advantageous way, the melting together of the cladding material and core material is improved by each individual suspension having a vacuum connection for connecting the preform to a central vacuum system. The vacuum in this case draws off the air located between the materials, so that air inclusions between the layers can be avoided.

In order to achieve a synchronous advancement of all the preforms arranged in the supporting plate, and consequently reliable production of largely identical fiber diameters, it is proposed according to the invention that the supporting plate can be driven and braked by a geared motor for the advancement of the preforms through the use of a threaded spindle and guide.

It is in this case provided that the supporting plate can be manually and/or automatically made to travel into a service position, so that the supporting plate can move quickly back into its service position after the drawing operation.

It is further provided according to the invention that the fiber furnace has at the output end of the heating bushes a flow collar, through the use of which an air cushion can be created for the delayed cooling of the glass fibers. It has in this case been advantageously found that, with this flow collar, specific cooling profiles can be achieved for the glass fibers.

It is provided according to the invention that a cooling zone for cooling the glass fibers is arranged downstream of the fiber furnace. It has been found to be advantageous in this case for the cooling zone to have a funnel through which the glass fibers can be passed to the drawing and sizing installation. The funnel is arranged downstream of the fiber furnace and positioned underneath the flow collar in the cooling zone, so that, when the device is being set up, the first molten drops of glass of the preforms can be specifically guided to the setting-up location at the drawing and sizing installation. When they fall down, the drops of glass hit the funnel and slide with the following glass fiber through the funnel to the drawing and sizing installation, where they can be taken up, preferably manually, and placed on size rollers in the sizing installation.

It has been found to be advantageous in this case for the glass fibers of each furnace half to be able to be passed over a respective size roller. This consequently achieves the effect that a large number of glass fibers can be produced and further processed simultaneously. The glass fibers are in this case respectively passed around the corresponding size roller, the glass fibers being arranged in band form next to one another, and uniformly provided with sizing agent. In this case it is provided that the glass fibers do not touch one another.

A further advantageous embodiment of the device is achieved by the size rollers being arranged at a predetermined angle in relation to the principal matrix axes. Consequently, the setting-up of the device at the beginning of drawing is made easier and the effect is also achieved that the glass fibers are at an adequate distance from one another while they are being sized or coated.

According to a preferred feature of the invention, the matrix configuration has principal matrix axes disposed at a given offset angle with respect to one another.

According to another feature of the invention, the heating bushes are disposed such that the matrix configuration forms a rhomboid configuration.

According to yet another feature of the invention, the matrix configuration has matrix axes; and the heating bushes are disposed such that respective distances between directly neighboring ones of the heating bushes on each of the matrix axes are substantially identical.

According to a further feature of the invention, the heating bushes are disposed in one plane.

According to another feature of the invention, each of the heating bushes has an associated one of the preforms assigned thereto.

According to yet another feature of the invention, the fiber furnace has at least 110 heating bushes.

According to a further feature of the invention, the matrix configuration has a first principal matrix axis and a second principal matrix axis, the matrix configuration has 10 of the heating bushes disposed in a direction of the first principal matrix axis and has 11 of the heating bushes disposed in a direction of the second principal matrix axis.

According to another feature of the invention, the fiber furnace includes a temperature controller with individual controllers configured to individually control temperatures in the heating bushes.

According to a further feature of the invention, the individual controllers have respective measuring and compensating devices for adjusting temperatures in the heating bushes in relation to temperatures in neighboring heating bushes.

According to yet a further feature of the invention, each of the heating bushes has at least one heating element; and each of the heating bushes has at least one diffuser provided between the at least one heating element and a respective one of the preforms for diffusing a heating radiation.

According to a further feature of the invention, each of the heating bushes has a number of separately activatable heating coils; and each of the heating bushes has at least one diffuser provided between the heating coils and a respective one of the preforms for diffusing a heating radiation.

According to another feature of the invention, the at least one diffuser includes a quartz glass tube; and the follow-up device feeds the preforms such that a corresponding one of the preforms passes through the quartz glass tube.

According to a further feature of the invention, each of the heating bushes has a flow device for creating a laminar air flow in a respective one of the heating bushes.

According to a further feature of the invention, the flow device includes an extension part provided at a lower portion of the respective one of the heating bushes; and the extension part has no heating elements assigned thereto.

According to another feature of the invention, each of the heating bushes has a flow device for creating a laminar air flow in a respective one of the heating bushes; the flow device includes an extension part provided at a lower portion of the respective one of the heating bushes such that the at least one diffuser and the extension part form a one-piece element; and the extension part has no heating elements assigned thereto.

According to yet another feature of the invention, the flow device includes at least one flow baffle disposed at an upper end of the respective one of the heating bushes such that an annular air gap with a given gap width is formed between a respective one of the preforms and the at least one flow baffle for venting air through the annular air gap.

According to a further feature of the invention, the follow-up device has a supporting plate with individual suspensions for individually receiving the preforms.

According to another feature of the invention, the individual suspensions on the supporting plate form a matrix configuration corresponding to the matrix configuration formed by the heating bushes.

According to a further feature of the invention, each of the individual suspensions has a vacuum connection for connecting each respective one of the preforms to a central vacuum system.

According to a further feature of the invention, the follow-up device includes a geared motor, a threaded spindle and a guide; and the geared motor is configured to selectively drive and brake the supporting plate via the threaded spindle and the guide for advancing the preforms.

According to another feature of the invention, the supporting plate is configured to be manually and/or automatically movable into a service position.

According to a further feature of the invention, the fiber furnace has a flow collar disposed at an output end of the heating bushes for creating an air cushion for a delayed cooling of the glass fibers.

According to a further feature of the invention, a cooling zone is provided downstream of the fiber furnace for cooling the glass fibers.

According to another feature of the invention, the cooling zone includes a funnel disposed upstream of the drawing and sizing installation such that the glass fibers are passed through the funnel.

According to yet another feature of the invention, the drawing and sizing installation includes a first size roller and a second size roller disposed such that glass fibers from a first half of the fiber furnace pass over the first size roller and glass fibers from a second half of the fiber furnace pass over the second size roller.

According to a further feature of the invention, the drawing and sizing installation includes size rollers disposed at a given angle in relation to the principal matrix axes.

According to yet another feature of the invention, the fiber furnace is configured to receive preforms for producing multicomponent glass fibers.

With the objects of the invention in view there is also provided, a method for producing glass fibers, the method includes the steps of:
introducing, with a follow-up device, preforms into heating bushes of a fiber furnace;
producing glass fibers from the preforms by drawing the glass fibers with a given constant diameter from the heating bushes;
providing the heating bushes as a configuration that ensures that the glass fibers are drawn without crossing and touching one another;
cooling the glass fibers in a predetermined manner in a cooling zone downstream of the fiber furnace; and
passing the glass fibers via a drawing installation to a making-up device.

In other words, according to the invention, there is provided a method for producing glass fibers from preforms with a device according to the invention, wherein the preforms are introduced by a follow-up device into the heating bushes of the fiber furnace, and the glass fibers drawn from the heating bushes are cooled over a downstream cooling zone and passed on via a drawing installation to a making-up device, wherein the glass fibers are drawn with a predetermined constant diameter from the heating bushes and cooled over the cooling zone in a predetermined way and wherein, through the configuration or layout of the heating bushes, a drawing of the glass fibers without touching or crossing one another is ensured.

The glass fibers are drawn with a constant drawing rate from the heating bushes. The optical requirements imposed on the glass material of the glass fibers and the physical properties of the fiber bundles produced with them are ensured in an adequate way by avoiding fluctuations of the drawing rate on the individual glass fibers. In this case, according to the mass flow law, the ratio of the mass of the molten glass material and the mass of the glass material drawn off as glass fiber is kept constant.

This is achieved by each preform being drawn with a controlled temperature profile in the associated heating bush and/or advancement of the supporting plate. Furthermore, it is provided that the glass fibers drawn from the heating bushes are cooled over a predetermined temperature profile.

In this case, according to the invention the special geometrical configuration of the heating bushes ensures that the glass fibers can be drawn from the fiber furnace and passed over the cooling zone without the glass fibers touching one another or crossing one another. Furthermore, it is consequently possible after the cooling zone for the glass fibers to be uniformly wetted with sizing agent in a band-like manner on the downstream size rollers of a sizing installation.

The drawing of the glass fibers is performed by the glass fibers being drawn at the same drawing rate by a drawing-off roller. In this case, as already on the size rollers, the glass fibers lie on the drawing-off roller likewise without touching or crossing. After that, the glass fibers can be bundled and made up, so that fiber bundles or fiber cables with a large number of glass fibers can be produced simultaneously.

It is proposed according to the invention that the drawing rate of the drawing-off roller and the advancement of the supporting plate are controlled through the use of an electronic data processing installation. It is also provided that the temperatures in the heating bushes are controlled through the use of the electronic data processing installation. Finally, it is provided according to the invention that the glass fibers are made up without causing any reactions or feedback. Preferably, the glass fibers are passed around the drawing-off roller through the use of a secondary roller, in order to obtain greatest possible drawing-off friction on the surface of the roller. From the secondary roller, the glass fibers are passed to the reaction-free or feedback-free making-up device, thereby preventing forces which compromise the constancy of the drawing rate and consequently the accuracy of the diameter from being exerted on a number of glass fibers or individual glass fibers during making-up or assembly of the fibers.

A preferred mode of the method according to the invention includes drawing each of the preforms with a controlled temperature profile in an associated one of the heating bushes.

Another mode of the method according to the invention includes holding the preforms with a supporting plate of the follow-up device; and drawing each of the preforms with a controlled advancement of the supporting plate.

Yet another mode of the method according to the invention includes cooling the glass fibers over a given temperature profile.

Another mode of the method according to the invention includes uniformly wetting the glass fibers with a sizing agent by rolling the glass fibers as a band over size rollers of a sizing installation provided downstream from the cooling zone.

A further mode of the method according to the invention includes drawing each of the glass fibers at a substantially identical drawing rate by using a drawing-off roller.

Another mode of the method according to the invention includes controlling a drawing rate of a drawing-off roller and an advancement of the supporting plate by using an electronic data processing installation.

Another mode of the method according to the invention includes controlling temperatures in the heating bushes by using an electronic data processing installation.

A further mode of the method according to the invention includes making up, with the making-up device, the glass fibers without causing any reactions or feedback on devices upstream of the making-up device.

Finally, to achieve the object according to the invention, heating bushes with the above-described features for use in fiber furnaces are proposed.

With the objects of the invention in view there is also provided, a heating bush configuration, including:
a heating bush configured to receive a preform; and
the heating bush having a heating element and a diffuser provided between the heating element and the preform for diffusing a heating radiation.

According to another feature of the invention, the heating element includes separately activatable heating coils.

According to yet another feature of the invention, the diffuser includes a quartz glass tube disposed such that the preform is passed through the quartz glass tube.

According to a further feature of the invention, the heating bush has a flow device for creating a laminar air flow in the heating bush.

According to another feature of the invention, the flow device includes an extension part provided at a lower portion of the heating bush, and the extension part has no heating element assigned thereto.

According to yet another feature of the invention, the diffuser and the extension part form a one-piece element.

According to another feature of the invention, the flow device includes at least one flow baffle disposed at an upper end of the heating bush such that an annular air gap with a given gap width is formed between the preform and the at least one flow baffle for venting air through the annular air gap.

Other features which are considered as characteristic for the invention are set forth in the appended claims.

Although the invention is illustrated and described herein as embodied in a device and method for producing glass fibers, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a device according to the invention;

FIG. 2 is a diagrammatic plan view of a fiber furnace from above with a configuration of heating bushes according to the invention;

FIG. 3 is a diagrammatic sectional view of a heating bush along the longitudinal axis; and

FIG. 4 is a diagrammatic sectional view of a heating bush according to FIG. 3 during the drawing of a preform.

### DESCRIPTION OF THE PREFERRED EMBODIMENTS

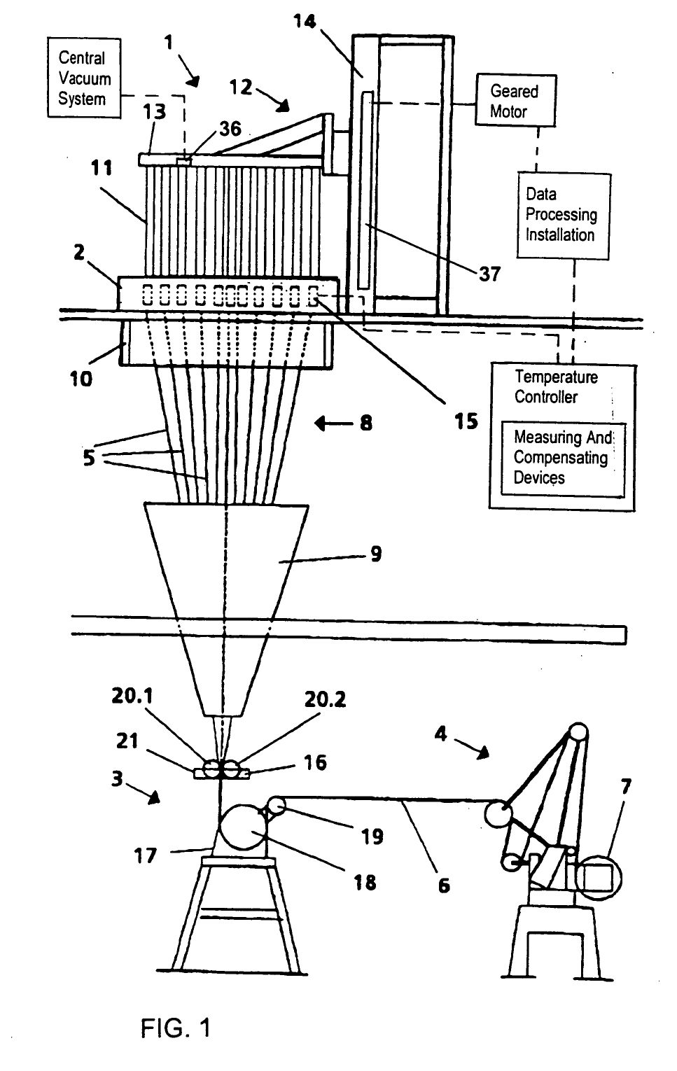

Referring now to the figures of the drawings in detail and first, particularly, to FIG. 1 thereof, there is shown a device 1 according to the invention with the fiber furnace 2 and a drawing and sizing installation 3. Provided downstream of the drawing and sizing installation 3 is a making-up device 4, which makes up or assembles the produced glass fibers or optical fibers 5 as fiber bundles 6 on take-up spools 7 without causing any reactions or feedback on, for example, the drawing and sizing installation 3.

Provided between the fiber furnace 2 and the sizing installation 3 is the cooling zone 8, the glass fibers 5 being passed through a funnel 9. The cooling zone 8 has a flow collar 10, which is provided directly downstream of the fiber furnace 2 and serves the purpose of cooling the glass fibers 5 with a predetermined temperature profile.

The optical fibers or glass fibers 5 are drawn off from preforms 11, the preforms being introduced into the fiber furnace 2 through the use of a follow-up device 12. For this purpose, the individual preforms 11 are fastened to a supporting plate 13 of the follow-up device 12. The supporting plate 13 is guided in a guide 14 through the use of a driving spindle, preferably through the use of a ballscrew, and is driven by a geared motor. In this case, during the normal following-up of the preforms 11, the supporting plate 13 is driven with the advancement intended for drawing. If the drawing of the glass fibers 5 is ended, the supporting plate 13 can be moved manually or else, for example at the end of the preforms 11, automatically back into a service position, in which the remains of the preforms can be removed and new preforms 11 can be fastened on the supporting plate 13.

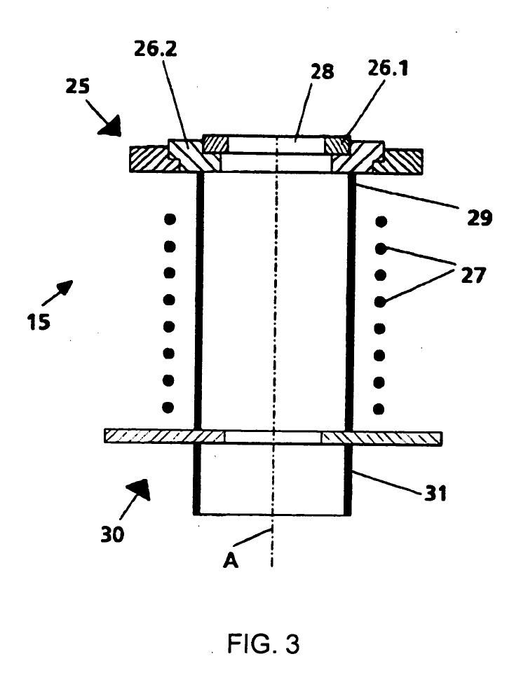

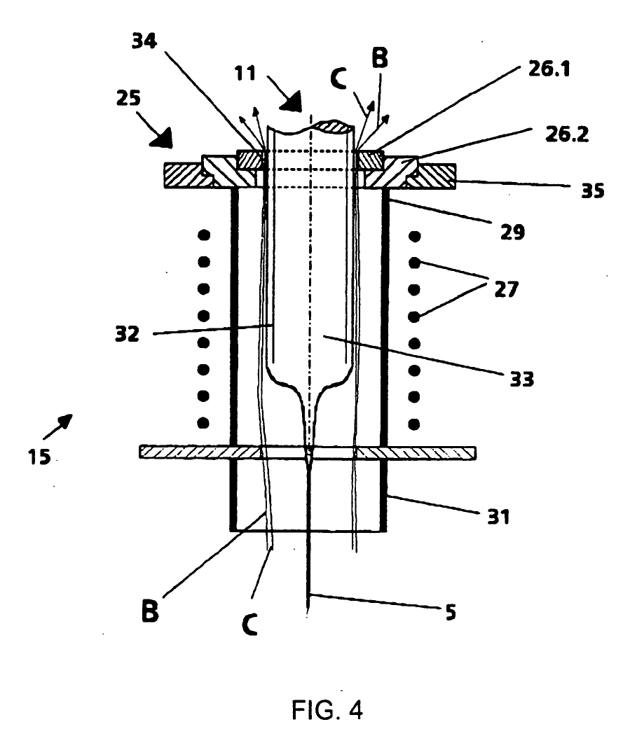

The fiber furnace 2 has a plurality of heating bushes 15, which are explained in more detail in FIGS. 3 and 4. The preforms 11 are introduced by the follow-up device 12 into the heating bushes 15 in such a way that the glass fibers 5 can be passed continuously via the sizing installation 16 from the drawing installation 17 to the making-up device 4. For this purpose, the drawing installation 17 has a drawing-off roller 18, the glass fibers 5 being passed around the drawing-off roller 18 by a secondary roller 19, the glass fibers 5 lying next to one another without touching one another, so that the glass fibers 5 are drawn with the same drawing rate by the drawing-off roller 18. Consequently, the adhesive friction of the glass fibers 5 on the drawing-off roller 18 can be optimally maintained and all the glass fibers 5 are drawn from the heating bushes 15 of the fiber furnace 2 with a substantially identical drawing rate.

An electronic data processing installation controls in this case the drawing operation in a corresponding way in dependence on the advancement of the follow-up device 12 and the drawing rate. The making-up device 4 sets itself automatically to the speed prescribed by the drawing-off roller 18, with which the fiber bundles 6 can be wound up.

Upstream of the drawing-off roller 18, the glass fibers 5 are drawn through the coating installation or sizing installation 16. The glass fibers 5 are thereby taken up, disposed in a band-like manner next to one another, by two size rollers 20.1, 20.2. It is provided that the glass fibers 5 of one half of the fiber furnace 2 in each case are passed over one of the size rollers 20.1, 20.2. The size rollers 20.1, 20.2 are immersed partly, i.e. up to 45%, in a reservoir 21. The glass fibers 5 are uniformly wetted with sizing agent via the surface of the size rollers 20.1, 20.2. Subsequently, the glass fibers 5, still disposed in a band-like manner next to one another, are taken up by the drawing-off roller 18.

Only schematically shown in FIG. 1 is an individual suspension 36 with a vacuum connection for connecting the preforms to a central vacuum system. Also only schematically shown are the geared motor and the threaded spindle 37 for driving and braking the supporting plate. Further, FIG. 1 schematically shows a temperature controller with measuring and compensating devices for adjusting temperatures in the heating bushes. Also shown is a data processing installation for controlling for example the drawing rate of a drawing-off roller, the advancement of the preforms and/or the temperature in the heating bushes.

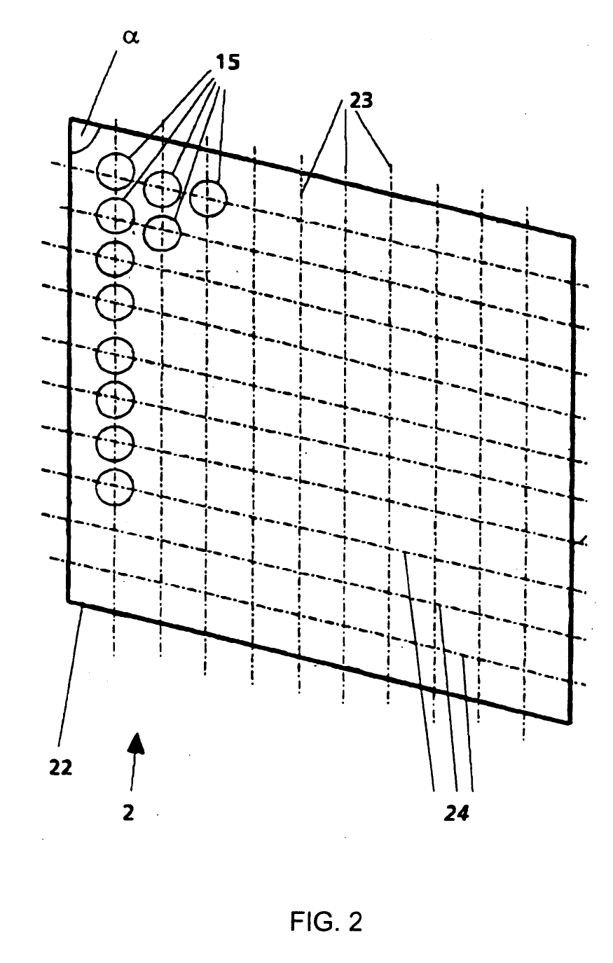

Represented in FIG. 2 is the fiber furnace 2 with the configuration of heating bushes 15 provided according to the invention. The heating bushes 15 are disposed in one plane in the form of a matrix 22. The matrix 22 has matrix axes 23, 24 which are disposed at an angle with respect to one another and at the crossing points of which the heating bushes 15 are disposed. The neighboring heating bushes 15 are disposed at the same distance from one another in each direction of the matrix axes 23, 24. The matrix axes 23, 24 are disposed at a given angle α in relation to one another. The angle α is chosen according to the invention to be less than 90°.

In an advantageous embodiment, the fiber furnace 2 has a matrix structure of 10×11 with a total of 110 heating bushes 15. In each case half of the glass fibers 5 drawn from the preforms 11 is respectively passed via a size roller 20.1, 20.2. The size rollers 20.1, 20.2 are in this case disposed at a given angle in relation to the corresponding principal matrix axis, in order to ensure an optimum spacing of the glass fibers 5 on the size roller 20.1, 20.2.

In FIG. 3, a heating bush 15 is represented in cross section in relation to the longitudinal axis A. The heating bush 15 has at the upper end 25 an inner orifice flange or flow baffle 26.1 and an outer flow baffle 26.2, with which a laminar air flow can be established within the heating bush 15 during the melting operation. The heating bush 15 also has heating elements 27, which are electrically operated. The heating elements 27 are provided as heating coils around the aperture 28, through which the preform 11 can be passed. Through the use of a diffuser 29 formed as a quartz tube, the heating coil 27 is covered with respect to the preform 11. Provided at the lower end 30 of the heating bush 15 is an extension 31, which acts as a flow collar. With the extension 31 it is possible to achieve a predetermined temperature profile for the operation of cooling the glass fibers 5 after melting. The extension 31 may in this case be produced in one piece with the quartz glass. A separate copper bush has also been found to be expedient here as the extension 31.

In FIG. 4, the heating bush 15 is shown with a preform 11 that has been inserted. The preform 11 has a cladding tube 32 and a core rod 33. The preform 11 is introduced into the heating bush 15 at the upper end 25.

The flow baffles 26.1, 26.2, which are placed into the upper opening of the heating bush 15 around the pre-form 11, have the effect that an annular gap 34 is formed between the inner flow baffle 26.1 and the preform 11. Otherwise, the opening is covered by the flow baffles 26.1, 26.2, wherein one of the flow baffles 26.2 rests on a plate 35. The air heated up by the heating coils 27 consequently flows upward along the preform 11 in the direction of the arrows B, C out of the heating bush 15. The flow baffles 26.1, 26.2 achieve the effect that the air flow remains laminar, that is to say that no undesired cooling effects occur and no turbulences are produced within the heating bush 15 by the air flow. The temperature profile can, however, be deliberately changed within the heating bush 15. This has the effect that the annular gap 34 created between the outer flow baffle 26.2 and the preform 11 can be changed, for example in that the inner flow baffle 26.1 is removed. This achieves the effect that the annular gap becomes larger. This leads to more air being directed past the preform 11, and consequently a greater amount of heat being removed from the heating bush 15, and then no longer being available to the melting operation.

In order to set the temperature profile within the heating bush 15 additional cooling elements can be used, through the use of which heat can be removed in a controlled manner from the heating coils 27. The cooling elements may be made of metal, preferably of copper, and be embedded in the material carrying the heating coils 27.

From the heating bush 15, the glass is drawn in the form of the glass fiber 5, having a fiber cladding and a fiber core, and is passed through the extension 31, where the glass fiber 5 is already cooled in a predetermined way. A specific temperature profile can be set for the cooling operation through the use of the length of the extension 31. It is also possible to set a predetermined temperature profile for the operation of cooling the glass fibers 5 by special measures for admitting air to the extension 31 or by a configuration or geometry of the extension 31. In this case, it is advantageously achieved that a specific air flow is created on the glass fiber 5 by the extension 31.

1. A device for producing optical glass fibers, comprising:
a fiber furnace having heating bushes disposed as a matrix configuration for simultaneously receiving a number of preforms;
a follow-up device configured to hold and feed the preforms into said heating bushes;
a drawing and sizing installation configured to receive glass fibers drawn from the preforms in said heating bushes such that the glass fibers lie next to one another as a band when being received by said drawing and sizing installation; and
a making-up device configured to receive the glass fibers from said drawing and sizing installation.

2. The device according to claim 1, wherein said matrix configuration has principal matrix axes disposed at a given offset angle with respect to one another.

3. The device according to claim 1, wherein said heating bushes are disposed such that said matrix configuration forms a rhomboid configuration.

4. The device according to claim 1, wherein:
said matrix configuration has matrix axes; and
said heating bushes are disposed such that respective distances between directly neighboring ones of said heating bushes on each of said matrix axes are substantially identical.

5. The device according to claim 1, wherein said heating bushes are disposed in one plane.

6. The device according to claim 1, wherein each of said heating bushes has an associated one of the preforms assigned thereto.

7. The device according to claim 1, wherein said fiber furnace has at least 110 heating bushes.

8. The device according to claim 7, wherein said matrix configuration has a first principal matrix axis and a second principal matrix axis, said matrix configuration has 10 of said heating bushes disposed in a direction of the first principal matrix axis and has 11 of said heating bushes disposed in a direction of the second principal matrix axis.

9. The device according to claim 1, wherein said fiber furnace includes a temperature controller with individual controllers configured to individually control temperatures in said heating bushes.

10. The device according to claim 9, wherein said individual controllers have respective measuring and compensating devices for adjusting temperatures in said heating bushes in relation to temperatures in neighboring heating bushes.

11. The device according to claim 1, wherein:
each of said heating bushes has at least one heating element; and
each of said heating bushes has at least one diffuser provided between said at least one heating element and a respective one of the preforms for diffusing a heating radiation.

12. The device according to claim 1, wherein:
each of said heating bushes has a number of separately activatable heating coils; and
each of said heating bushes has at least one diffuser provided between said heating coils and a respective one of the preforms for diffusing a heating radiation.

13. The device according to claim 11, wherein:
said at least one diffuser includes a quartz glass tube; and
said follow-up device feeds the preforms such that a corresponding one of the preforms passes through the quartz glass tube.

14. The device according to claim 1, wherein each of said heating bushes has a flow device for creating a laminar air flow in a respective one of said heating bushes.

15. The device according to claim 14, wherein:
said flow device includes an extension part provided at a lower portion of said respective one of said heating bushes; and
said extension part has no heating elements assigned thereto.

16. The device according to claim 11, wherein:
each of said heating bushes has a flow device for creating a laminar air flow in a respective one of said heating bushes;
said flow device includes an extension part provided at a lower portion of said respective one of said heating bushes such that said at least one diffuser and said extension part form a one-piece element; and
said extension part has no heating elements assigned thereto.

17. The device according to claim 14, wherein said flow device includes at least one flow baffle disposed at an upper end of said respective one of said heating bushes such that an annular air gap with a given gap width is formed between a respective one of the preforms and said at least one flow baffle for venting air through the annular air gap.

18. The device according to claim 1, wherein said follow-up device has a supporting plate with individual suspensions for individually receiving the preforms.

19. The device according to claim 18, wherein said individual suspensions on said supporting plate form a matrix configuration corresponding to said matrix configuration formed by said heating bushes.

20. The device according to claim 18, wherein each of said individual suspensions has a vacuum connection for connecting each respective one of the preforms to a central vacuum system.

21. The device according to claim 18, wherein:
said follow-up device includes a geared motor, a threaded spindle and a guide; and
said geared motor is configured to selectively drive and brake said supporting plate via said threaded spindle and said guide for advancing the preforms.

22. The device according to claim 18, wherein said supporting plate is configured to be manually movable into a service position.

23. The device according to claim 18, wherein said supporting plate is configured to be automatically movable into a service position.

24. The device according to claim 1, wherein said fiber furnace has a flow collar disposed at an output end of said heating bushes for creating an air cushion for a delayed cooling of the glass fibers.

25. The device according to claim 1, including a cooling zone provided downstream of said fiber furnace for cooling the glass fibers.

26. The device according to claim 25, wherein said cooling zone includes a funnel disposed upstream of said drawing and sizing installation such that the glass fibers are passed through said funnel.

27. The device according to claim 1, wherein said drawing and sizing installation includes a first size roller and a second size roller disposed such that glass fibers from a first half of said fiber furnace pass over said first size roller and glass fibers from a second half of said fiber furnace pass over said second size roller.

28. The device according to claim 2, wherein said drawing and sizing installation includes size rollers disposed at a given angle in relation to the principal matrix axes.

29. The device according to claim 1, wherein said fiber furnace is configured to receive preforms for producing multicomponent glass fibers.

30. A method for producing glass fibers, the method which comprises:
introducing, with a follow-up device, preforms into heating bushes of a fiber furnace;
producing glass fibers from the preforms by drawing the glass fibers with a given constant diameter from the heating bushes;
providing the heating bushes as a configuration that ensures that the glass fibers are drawn without crossing and touching one another;
cooling the glass fibers in a predetermined manner in a cooling zone downstream of the fiber furnace; and
passing the glass fibers via a drawing installation to a making-up device.

31. The method according to claim 30, which comprises drawing each of the preforms with a controlled temperature profile in an associated one of the heating bushes.

32. The method according to claim 30, which comprises:
holding the preforms with a supporting plate of the follow-up device; and
drawing each of the preforms with a controlled advancement of the supporting plate.

33. The method according to claim 30, which comprises cooling the glass fibers over a given temperature profile.

34. The method according to claim 30, which comprises uniformly wetting the glass fibers with a sizing agent by rolling the glass fibers as a band over size rollers of a sizing installation provided downstream from the cooling zone.

35. The method according to claim 30, which comprises drawing each of the glass fibers at a substantially identical drawing rate by using a drawing-off roller.

36. The method according to claim 32, which comprises controlling a drawing rate of a drawing-off roller and an advancement of the supporting plate by using an electronic data processing installation.

37. The method according to claim 30, which comprises controlling temperatures in the heating bushes by using an electronic data processing installation.

38. The method according to claim 30, which comprises making up, with the making-up device, the glass fibers without causing any reactions on devices upstream of the making-up device.

39. A heating bush configuration, comprising:
a heating bush configured to receive a preform; and
said heating bush having a heating element and a diffuser provided between said heating element and the preform for diffusing a heating radiation.

40. The heating bush configuration according to claim 39, wherein said heating element includes separately activatable heating coils.

41. The heating bush configuration according to claim 39, wherein said diffuser includes a quartz glass tube disposed such that the preform is passed through said quartz glass tube.

42. The heating bush configuration according to claim 39, wherein said heating bush has a flow device for creating a laminar air flow in said heating bush.

43. The heating bush configuration according to claim 42, wherein said flow device includes an extension part provided at a lower portion of said heating bush, and said extension part has no heating element assigned thereto.

44. The heating bush configuration according to claim 43, wherein said diffuser and said extension part form a one-piece element.

45. The heating bush configuration according to claim 42, wherein said flow device includes at least one flow baffle disposed at an upper end of said heating bush such that an annular air gap with a given gap width is formed between the preform and said at least one flow baffle for venting air through the annular air gap.
